(19) United States
(12) Patent Application Publication
(10) Pub. No.: US 2008/0237008 A1
(43) Pub. Date: Oct. 2, 2008

(54) Dust-proof switch

(76) Inventor: Ming-Han Lin, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/727,319

(22) Filed: Mar. 26, 2007

(51) Int. Cl. H01H 1/64

(52) U.S. Cl. 200/302.1

(57) ABSTRACT

A dust-proof switch includes a housing inlayed with a plurality of terminals, an inner lid, an outer lid, a dust-proof cover and a shielding. The housing has a body; an accommodating recess is defined in the body. The accommodating recess includes a first cavity and a second cavity. The inner lid and the outer lid are respectively disposed in the first cavity and the second cavity. The inner lid has a dome and two U shaped ears defined at two symmetrical ends of the dome. The dust-proof cover is disposed on the housing and wedged in the U shaped ears of the inner lid to fix the domes.

### BACKGROUND OF THE INVENTION

1. Field of the Invention

The present invention relates to a switch, and more particularly to a dust-proof switch.

2. The Related Art

Many kinds of push-button switches are increasingly utilized in the electrical devices, such as mobile phones, cameras, keyboards and so on. Such push-button switch usually has a housing. Two domes are assembled in the housing. In order to fix the domes to the housing firmly, a thermal adhesive pad shaped as the circle domes is used to adhere to the housing of the switch. By another way, the dome has a special ears extending from the opposite sides of the dome to melt the dome to the housing.

However, when assembling the domes to the housing, it is hard to obtain a suitable shape of the thermal adhesive pad and paste the thermal adhesive pad to the housing of the switch. It is also inconvenient to melt the domes with special ears to the housing of the switch.

### SUMMARY OF THE INVENTION

An object of the present invention is to provide a dust-proof switch having two domes including a housing inlayed with a set of terminals, an inner lid, an outer lid, a dust-proof cover and a shielding. The housing has a first cavity in the top and a second cavity under the first cavity. A couple of first troughs are defined at a couple of opposite corners of the housing, the first troughs are connecting to the first cavity. A couple of second troughs are defined at the other couple of opposite corners of the housing, the second troughs connect to the second cavity. A plurality of terminal is inlayed in the housing. The inner lid has a second dome. Two baseboards extend from two opposite sides of the second dome. A fixing portion bends and extends upwardly from the end of the baseboard. A roof bends and extends inwardly from the end of the fixing portion. The baseboards, fixing portions and roofs form a couple of U shaped ears. The outer lid has a first dome and two contacting portions extend outwardly from two opposite lateral sides of the dome The outer lid and the inner lid are disposed in the first cavity and the second cavity respectively, with the first dome of the outer lid disposed in the first cavity and the contacting portions disposed in the first troughs. The second dome of the inner lid is disposed in the second cavity, with the U shaped ears of the inner lid disposed in the second troughs. The dust-proof cover is defined on the housing and wedged in the U shaped ears of the inner lid in the bottom. The shielding is disposed on the dust-proof cover and latched with the housing, with the press-button of the dust-proof cover disposed in the hole of the shielding.

Therefore, when an external force pushes the button of the switch, the U shaped ears of the inner lid clashed to the dust-proof cover. So the domes is connected to the terminals steadily under the clashing force and the domes are easy to fix. And the external circuit can work regularly.

### BRIEF DESCRIPTION OF THE DRAWINGS

The present invention will be apparent to those skilled in the art by reading the following description of a preferred embodiment thereof, with reference to attached drawings, in which:

FIG. 1 is a perspective view of a dust-proof switch of the present invention;

FIG. 2 is an exploded view of the dust-proof switch of FIG. 1;

FIG. 3 is a perspective view of an inner lid shown in FIG. 2;

FIG. 4 is a perspective view of a housing shown in FIG. 2;

FIG. 5 is a perspective view of the housing which is inlayed with four terminals; and

FIG. 6 is a sectional view taken along the line of VI-VI of FIG. 1.

### DETAILED DESCRIPTION OF THE PREFERRED EMBODIMENT

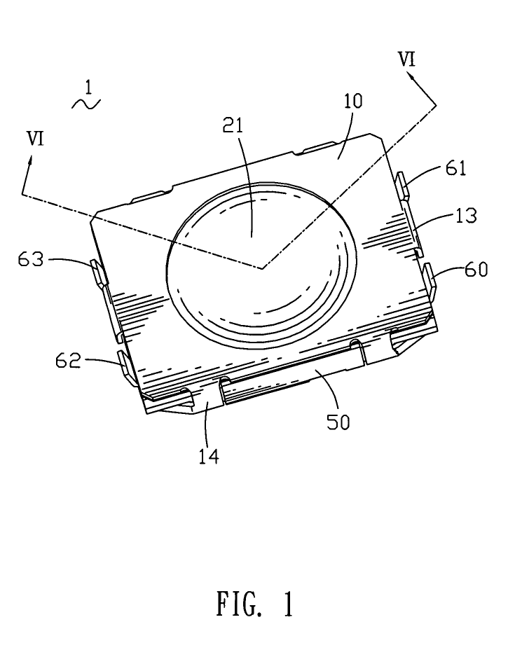

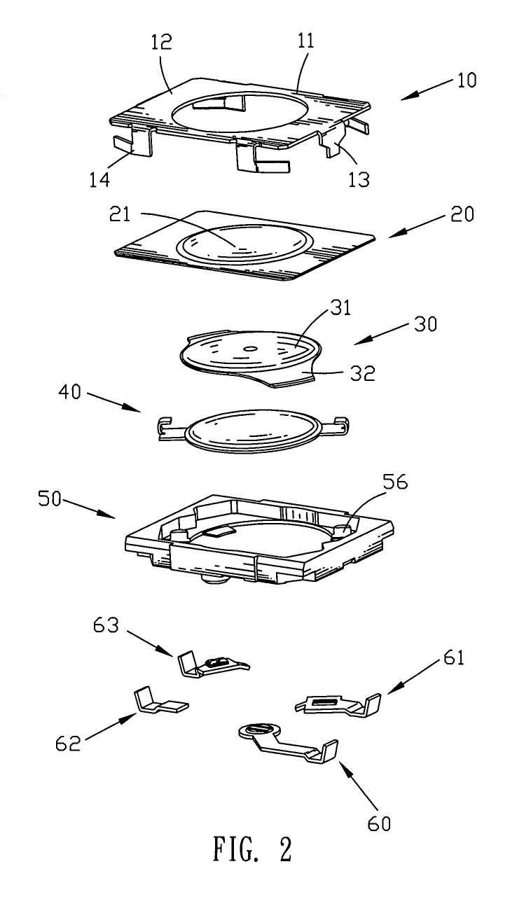

With reference to FIG. 1 and FIG. 2, a dust-proof switch 1 includes a shielding 10, a dust-proof cover 20, an outer lid 30, an inner lid 40 and a housing 50 inlayed with four contacts 60, 61, 62 and 63.

Referring to FIG. 2, the shielding 10 has a board 11 of oblong shape. A round hole 12 is opened in the center of the board 11. The middle portion of two opposite edges of the board 11 extend downwardly to form two position limiting portions 13. Another two opposite position of the board 11 extends downwardly to form four locking parts 14. The locking parts 14 are fastened on four locking troughs defined at four corners at the bottom surface of the housing 50.

The dust-proof cover 20 is a board of oblong configuration. A round protuberance is defined in the center of the board as a press-button 21 and matches the hole 12 of the shielding 10.

The outer lid 30 has a first dome 31. Two contacting portions 32 extend from two opposite sides of the first dome 31.

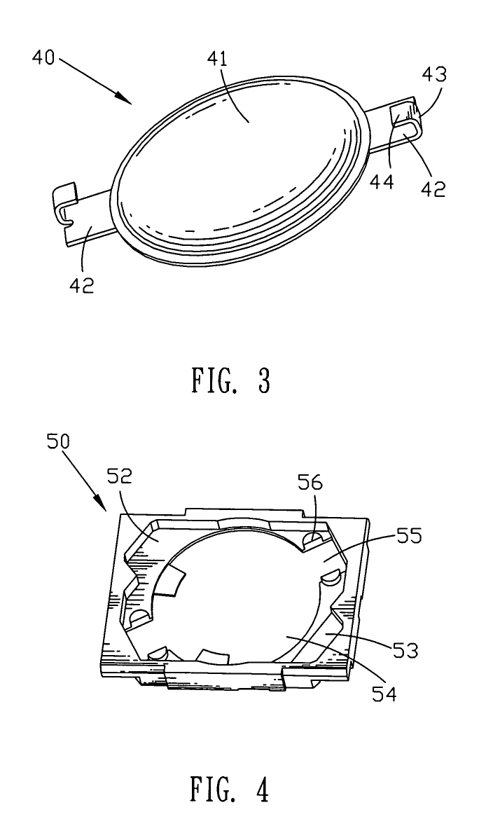

Pleas e refer to FIG. 3. The inner lid 40 has a second dome 41. Two baseboards 42 extend from two opposite sides of the second dome 41. The baseboard 42 bends and extends upwardly to form a fixing portion 43, and a roof 44 of oblong configuration extends from the end of the fixing portion 43 and then bends inwardly. The baseboards 42, fixing portions 43 and roofs 44 form a couple of U-shaped ears.

Referring to FIG. 4 and FIG. 6, the housing 50 is approximately of oblong configuration. The housing 50 has a first cavity 51 in the top communicating to the top surface of the housing 50 and a second cavity 54 under the first cavity 51. A couple of first troughs 52 are defined at a couple of opposite corners of the housing 50, the first troughs 52 are connecting to the first cavity 51. A couple of second troughs 55 are defined at the other couple of opposite corners of the housing, the second troughs 55 connect to the second cavity 54. A supporting portion 53 protrudes from the bottom of a first trough 52. A couple of limitative semi-columns 56 are protruding outwardly beyond the bottom surface of the first cavity 51 where the first cavity 51 connects to the second troughs 55.

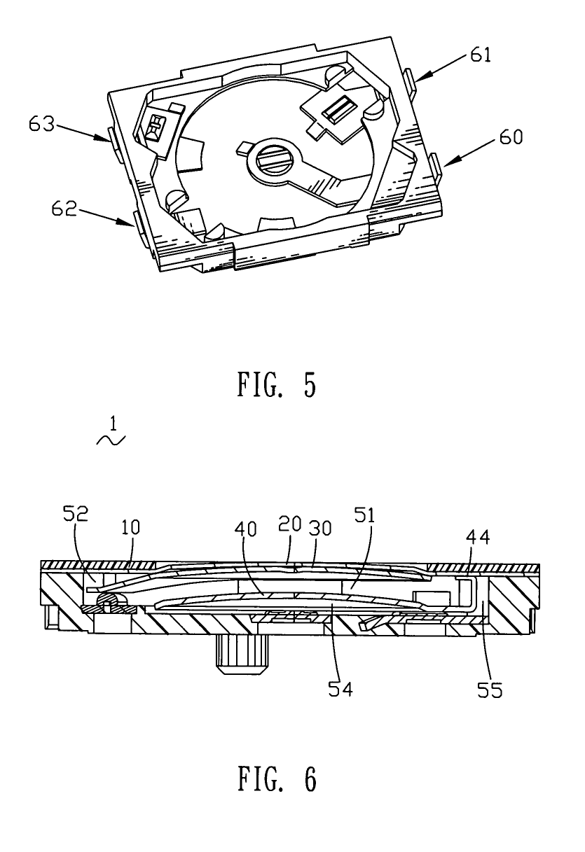

In accordance with FIG. 3, FIG. 5 and FIG. 6, in assembly, the terminal 60 is disposed in the second cavity 54 of the housing 50 and protruding outwardly from a side surface of the housing 50 to connect with an external circuit. The terminal 61 is disposed in the second cavity 54 and one of the second troughs 55, extending outwardly from a side surface of the housing 50 to connect with an external circuit. The terminal 62 is disposed in the other second trough 55 and extending outwardly beyond a side surface of the housing 50 to connect with an external circuit. The terminal 63 is disposed in a first trough 52 and extending outwardly from a side surface of the housing 50 to connect with an external circuit, and the height of the terminal 63 is approximately equal to the supporting portion 53. The inner lid 40 and the outer lid 30 are disposed in the housing 50 respectively, with the second dome 41 disposed in the second cavity 54 and the two baseboards 42 of the inner lid 40 disposed in the second troughs 55. So the inner lid 40 connects to the terminal 60, 61 and 63 in the bottom. The first dome 31 of the outer lid 30 is disposed in the first cavity 51 and the two contacting portions 32 of the outer lid 30 are disposed in the first troughs 52, with one contacting portion connects to the terminal 63 and the other contacting portion connects to the fixing portion 53. Then, the dust-proof cover 20 is defined on the housing 50, under the outer lid 30 and clashing to the roofs 43 of the inner lid 40. The shield 10 is disposed on the dust-proof cover 20, with the press-button 21 disposed in the hole 12. The position limiting portions 13 and the locking parts 14 buckle the shield 10 and the housing 50 together steadily.

When the switch 1 is assembled, the roofs 44 of the inner lid 40 clash to the dust-proof cover 20. So the inner lid 40, the outer lid 30 and the terminals 60, 61, 62, 63 can connect to each other firmly. Because the switch 1 adopts the clashing form, it is easy to fix the domes and it also can reduce the cost.

What is claimed is:

1. A dust-proof switch comprising:
a housing having a first cavity in the top and a second cavity under the first cavity, a couple of first troughs defined at a couple of opposite corners of the housing, the first troughs connecting to the first cavity, a couple of second troughs defined at the other couple of opposite corners of the housing, the second troughs connecting to the second cavity;
an inner lid having a second dome, two baseboards extending from two opposite sides of the second dome, a fixing portion extending and then bending upwardly from the en d of the baseboard, a roof bending and extending inwardly from the end of the fixing portion, the baseboards, fixing portions and roofs forming a couple of U-shaped ears;
an outer lid having a first dome and two contacting portions extending outwardly from two opposite lateral sides of the dome;
a dust-proof cover, disposed on the housing, having a round press-button protruding from the center; and
a shielding, having a board and a round hole in the center of the board;
wherein the outer lid and the inner lid are disposed in the first cavity and the second cavity respectively, the first dome of the outer lid disposed in the first cavity, the contacting portions of the outer lid disposed in the first troughs, the second dome of the inner lid disposed in the second cavity, the U-shaped ears of the inner lid disposed in the second troughs, the dust-proof cover disposed on the housing and wedged in the U-shaped ears of the inner lid in the bottom, the shielding disposed on the dust-proof cover and latched with the housing, the press-button of the dust-proof cover disposed in the hole of the shielding.

2. The dust-proof switch as claimed in claim 1, wherein a couple of position limitative semi-columns protrude outwardly beyond the bottom surface of the first cavity where the first cavity connects to the second troughs.

3. The dust-proof switch as claimed in claim 1, wherein a supporting portion protrudes from the bottom of the first trough, and a terminal is disposed in the other first trough, and the terminal approximately has an equal height with the supporting portion which connecting to the outer lid.
